(19) United States
(12) Patent Application Publication
(10) Pub. No.: US 2004/0231478 A1
(43) Pub. Date: Nov. 25, 2004

(54) Embroidery surface treating device

(76) Inventor: Teruaki Komatsu, Nara (JP)

Correspondence Address: KODA & ANDROLIA, 2029 CENTURY PARK EAST, SUITE 1430, LOS ANGELES, CA, 90067-3024, US

(21) Appl. No.: 10/489,464

(22) PCT Filed: Sep. 12, 2002
(86) PCT No.: PCT/JP02/09404

(30) Foreign Application Priority Data
Sep. 14, 2001 (JP) 2001279002

(51) Int. Cl. B26D 1/08

(52) U.S. Cl. 83/78

(57) ABSTRACT

An embroidery surface treating device comprising a cloth support table (12) having an air-permeable plate (12a) at an opening part on the upper surface thereof, a suction device (13) for sucking, from underside, an embroidery cloth (1) embroidered in a state stacked with one to a plurality of sheets (5) and placed on the cloth support table (12), and a cutter (18) for sequentially cutting and removing the needle threads (2) of embroidery patterns appearing on the surface of the uppermost sheet of the plurality of sheets stacked on the embroidery cloth (1) placed on the cloth support table (12) while relatively moving in parallel with the cloth support table (12) or for sequentially cutting off the needle threads (2) of embroidery patterns between any adjacent sheets (5) and (5) of the plurality of stacked sheets (5), whereby the needle threads erected to a desired height in a tufty and fluffy state can be formed easily and stereoscopic imposing embroidery patterns can be obtained.

### TECHNICAL FIELD

The present invention relates to an embroidery surface treating device for forming stereoscopic imposing embroidery patterns by making needle threads on the surface of an embroidered cloth in a tufty and fluffy state.

### BACKGROUND ART

As a method for obtaining embroidery patterns in a tufty and fluffy state, a method disclosed in Japanese Laid-open Patent Application Hei 11-315466 is available, for example.

In accordance with this method, as shown in FIGS. 5 and 6, an embroidery cloth 1 is embroidered, the needle threads 2 and the bobbin threads 3 appearing on the back surface of the cloth 1 are bonded and fixed to the cloth 1, and the intermediate portions of the needle threads 2 appearing on the surface of the cloth 1 are cut off with a cutter 4 along the broken line.

However, in order to cut off the intermediate portions of the needle threads 2 with the cutter 4, it is necessary to insert the tip of the cutter 4 between the needle threads 2 and the cloth 1 and to sequentially cut off the needle threads 2 one by one. Furthermore, the cloth 1 is apt to move and becomes unstable. For these reasons, it is difficult to efficiently carry out the cutting work, thereby requiring much labor and work time. In addition, when the needle threads 2 and the bobbin threads 3 are bonded and fixed to the cloth 1, the cloth 1 is hot-pressed. By this hot-pressing, the needle threads 2 on the surface of the cloth 1 are set in a fallen state. In order to erect all these needle threads 2, it is necessary to carry out some treatment, for example, to apply steam to them and to comb them. However, this also becomes a cause of requiring much labor and work time.

To solve these problems, the inventors of the present invention developed a method for erecting needle threads on the surface of an embroidery cloth in a tufty and fluffy state, and disclosed the method in Japanese Laid-open Patent Application 2001-40570. According to this method, as shown in FIG. 4, an embroidery cloth 1 is stacked with a plurality of sheets 5 and embroidered. The needle threads 2 and the bobbin threads 3 appearing on the back surface of the embroidery cloth 1 are bonded and fixed to the cloth 1. The intermediate portions 2a of the needle threads 2 appearing on the surface of the uppermost sheet are cut and removed, or the needle threads 2 are cut off between any two adjacent sheets of the plurality of sheets 5, and all the sheets 5 are removed from the cloth 1. As a result, the needle threads 2 in an erected state, having a length corresponding to the thickness of the sheets 5 placed below the cutting position, is obtained.

An object of the present invention is to provide a device capable of easily carrying out the embroidery pattern forming method disclosed in the above-mentioned Japanese Laid-open Patent Application 2001-40570.

### DISCLOSURE OF INVENTION

In order to attain the above-mentioned object, the embroidery surface treating device in accordance with the present invention comprises a cloth support table having an air-permeable plate at an opening part on the upper surface thereof, a suction device for sucking, from underside, an embroidery cloth embroidered in a state stacked with one to a plurality of sheets and placed on the cloth support table, and a cutter for sequentially cutting and removing the needle threads of embroidery patterns appearing on the surface of the uppermost sheet of the plurality of sheets stacked on the embroidery cloth placed on the cloth support table while relatively moving in parallel with the cloth support table or for sequentially cutting off the needle threads of embroidery patterns between any adjacent sheets of the plurality of stacked sheets.

With this configuration, the embroidery cloth is sucked to the plate on the cloth support table by the action of the suction device. Hence, the cloth does not move when the needle threads are cut and removed or cut off by the cutter, whereby work can be carried out smoothly. In addition, in the case when the needle threads of the embroidery patterns appearing on the surface of the uppermost sheet of the plurality of sheets stacked on the embroidery cloth are cut and removed, the needle threads having a length corresponding to the whole thickness of the one to the plurality of stacked sheets are left without change. In the case when the tip of the cutter is inserted between any adjacent sheets to cut off the needle threads, the needle threads having a length corresponding to the thickness of the sheets placed below the cutting position are left. Hence, when all the sheets are removed from the embroidery cloth, the needle threads on the surface of the cloth become an erected state so as to have a desired length. As a result, the needle threads are in a tufty and fluffy state, and stereoscopic imposing embroidery patterns can be obtained. This treatment can be carried out far more efficiently than the manual work wherein the needle threads are cut off one by one with a cutter. Therefore, the embroidery pattern forming method disclosed in the above-mentioned Japanese Laid-open Patent Application 2001-40570 can be carried out very easily at low cost.

In order to relatively move the cutter with respect to the cloth support table, the cutter should only be moved while the cloth support table is fixed, or conversely, the cloth support table should only be moved while the cutter is fixed.

Furthermore, the device described above is a device wherein the needle threads are cut and removed or cut off automatically. However, the device can be a semiautomatic device having a handy cutter. In this case, the device comprises a cloth support table having an air-permeable plate at an opening part on the upper surface thereof, a suction device for sucking, from underside, an embroidery cloth embroidered in a state stacked with one to a plurality of sheets and placed on the cloth support table, and a handy cutter for sequentially cutting and removing the needle threads of embroidery patterns appearing on the surface of the uppermost sheet of the plurality of sheets stacked on the embroidery cloth placed on the cloth support table or for sequentially cutting off the needle threads of embroidery patterns between any adjacent sheets of the plurality of stacked sheets.

### BRIEF DESCRIPTION OF DRAWINGS

FIG. 1 is a partially exploded schematic perspective view showing a device in accordance with an embodiment of the present invention;

FIG. 2 is a schematic perspective view showing a device in accordance with another embodiment;

FIG. 3 is a schematic perspective view showing a device in accordance with still another embodiment;

FIG. 4 is a view showing needle thread treatment in accordance with the present invention;

FIG. 5 is a plan view showing the state of needle threads on the surface of an embroidered cloth;

FIG. 6 is a view showing the conventional method for cutting off the needle threads of embroidery.

### BEST MODE FOR CARRYING OUT THE INVENTION

Next, embodiments in accordance with the present invention will be described below.

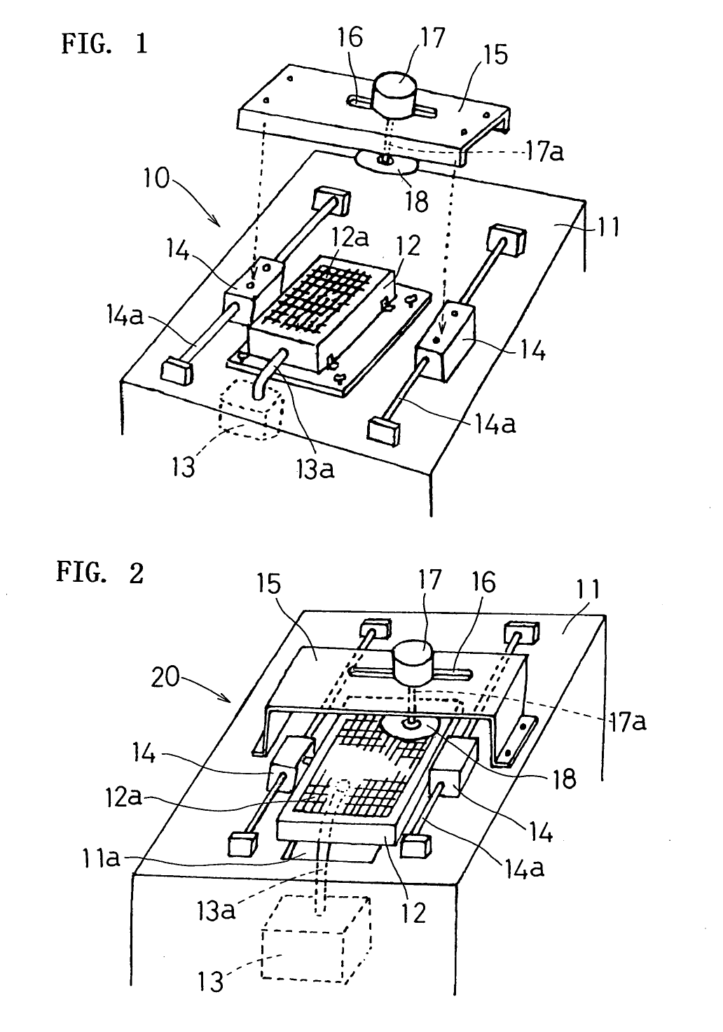

In FIG. 1, numeral 10 designates a treating device. A cloth support table 12 having the shape of a rectangular box is fixed to the upper surface of a workbench 11. An air-permeable plate 12a is provided at the opening part on the upper surface of the cloth support table 12. The interior of the cloth support table 12 is connected to a vacuum device 13 via a pipe 13a. The above-mentioned plate 12a comprises a fine net or a plate with a plurality of small holes or a combination of these. The plate 12a is reinforced by crosspieces provided on the lower surface thereof so as not to be deformed by suction from the vacuum device 13. Sliders 14 supported by slide guides 14a are provided on both sides of the cloth support table 12. A cutting tool post 15, both ends of which are fixed to the sliders 14 and 14, respectively, is provided so as to stride the cloth support table 12.

A slot 16 is formed in the cutting tool post 15 orthogonally to the slide guides 14a. A motor 17 having an output shaft 17a passing through this slot 16 is installed on the cutting tool post 15. A disc-shaped rotating cutter 18 is installed at the tip of the output shaft 17a. The blade of this disc-shaped rotating cutter 18 is selected so as to have a shape suited to cut and remove or cut off needle threads 2.

The sliders 14 are configured so that sliding is carried out by pushing the cutting tool post 15 by hand or configured so as to be appropriately provided with a known automatic sliding mechanism wherein, for example, a small motor is incorporated in one of the sliders 14, a pinion gear installed on its output shaft is engaged with a rack provided on the slide guide 14a so that sliding is carried out automatically. In addition, the position of the motor 17 can be adjusted manually along the slot 16, or the motor is fixed at any desired position. At least one of the cloth support table 12 and the rotating cutter 18 is adjustable in height.

The treating device 10 is configured as described above and used as described below.

As shown in FIG. 4, first, an embroidery cloth 1 is embroidered in a state stacked with one to a plurality of sheets 5, the needle threads 2 and bobbin threads 3 appearing on the back surface of the embroidery cloth 1 are bonded and fixed to the embroidery cloth 1. A cloth, a synthetic resin sheet or the like is used as the sheet 5 as necessary. One to a plurality of sheets are stacked so as to have a thickness corresponding to the target length of the needle threads. The cloth 1 with the sheets 5 stacked thereon in this state is placed on the plate 12a of the cloth support table 12 while the cloth 1 is directed downward. When the vacuum device 13 is operated, the embroidery cloth 1 and the sheets 5 are sucked and fixed to the plate 12a. Next, the cloth support table 12 or the rotating cutter 18 is adjusted in height. The motor 17 is driven to rotate the rotating cutter 18, and the cutting tool post 15 is slid.

In the case when the rotating cutter 18 is adjusted at a height corresponding to the surface of the uppermost sheet 5 of the stacked sheets 5, the intermediate portions 2a of the needle threads 2 positioned along the surface of the uppermost sheet 5, that is, the portions indicated by oblique lines, are cut off at the positions indicated by broken lines, as shown in FIG. 4, whereby the intermediate portions 2a are removed just in a state of being shaved off. At this time, in the case when the surface of the uppermost sheet 5 has projections and depressions or in the case when the rotating cutter 18 carries out cutting while slightly pushing the surface of the uppermost sheet 5, the uppermost sheet 5 is shaved off partially or wholly. Even if the uppermost sheet 5 is damaged, it is removed and thrown away, thereby causing no problem. After the intermediate portions are cut and removed as described above, the vacuum device 13 is stopped. The embroidery cloth 1 and the sheets 5 stacked thereon are removed from the cloth support table 12. When all the sheets 5 are separated from the embroidery cloth 1, the needle threads 2 are obtained in an erected state so as to have a height corresponding to the thickness of the one to the plurality of stacked sheets 5.

Instead of cutting and removing the intermediate portions 2a of the needle threads 2 appearing on the surface of the uppermost sheet 5 as described above, the needle threads 2 may be cut off as described below. The tip of the rotating cutter 18 is inserted between the plurality of stacked sheets 5, that is, between any two vertically adjacent sheets 5 and 5, to sequentially cut off the needle threads 2 positioned there while the sheets 5 above the needle threads 2 are removed as necessary. When the remaining sheets 5 are removed after all the needle threads 2 are cut off, the needle threads 2 are obtained in an erected state so as to have a height corresponding to the number of the sheets 5 stacked between the cutting position and the embroidery cloth 1.

Next, an embodiment shown in FIG. 2 will be described below. In FIG. 2, numeral 20 designates a treating device. A cloth support table 12 having the shape of a rectangular box is disposed on the upper surface of a workbench 11, and an air-permeable plate 12a is provided at the opening part on the upper surface of the cloth support table 12, just as in the case of the device shown in FIG. 1. In this embodiment, however, both sides of the cloth support table 12 are connected to sliders 14 so that the cloth support table 12 is moved. Small wheels, not shown, may be installed on the lower surface of the cloth support table 12 to facilitate the movement.

Under the cloth support table 12, a slot-shaped opening part 11a is provided in the workbench 11. The cloth support table 12 is connected to the vacuum device 13 via a pipe 13a passing through the opening part 11a. The vacuum device 13 may be fixed to the workbench 11 by using a configuration wherein the pipe 13a is formed of a flexible pipe. Or the vacuum device 13 may be made movable together with the cloth support table 12. A cutting tool post 15 is provided so as to stride the cloth support table 12 and fixed to the workbench 11. Just as in the case of the device shown in FIG. 1, a slot 16 is formed in the cutting tool post 15 orthogonally to the slide guides 14a. Furthermore, a motor 17 having an output shaft 17a passing through this slot 16 is provided on the cutting tool post 15. A disc-shaped rotating cutter 18 is installed at the tip of the output shaft 17a. The sliders 14 are configured so that sliding is carried out by pushing the cutting tool post 15 by hand or configured so as to be provided with a known automatic sliding mechanism wherein, for example, a small motor is incorporated in one of the sliders 14, a pinion gear installed on its output shaft is engaged with a rack provided on the slide guide 14a so that sliding is carried out automatically.

The treating device 20 is configured as described above, and the treatment itself for the embroidery cloth 1 is basically the same as that of the treating device shown in FIG. 1. In other words, an embroidery cloth 1 is stacked with one to a plurality of sheets 5 and embroidered. The needle threads 2 and bobbin threads 3 appearing on the back surface of the embroidery cloth 1 are bonded and fixed thereto. The embroidery cloth 1 with the sheets 5 stacked thereon is placed on the plate 12a of the cloth support table 12 while the cloth 1 is directed downward. The vacuum device 13 is operated, and the embroidery cloth 1 and the sheets 5 are sucked and fixed to the plate 12a. Next, the cloth support table 12 or the rotating cutter 18 is adjusted in height. The motor 17 is driven to rotate the rotating cutter 18, and the cloth support table 12 is slid. Hence, the intermediate portions 2a of the needle threads 2 positioned along the surface of the uppermost sheet 5 are cut and removed. Or the needle threads 2 are cut off between any two vertically adjacent sheets 5 and 5. As a result, the needle threads 2 are obtained in an erected state so as to have a height corresponding to the number of the stacked sheets 5.

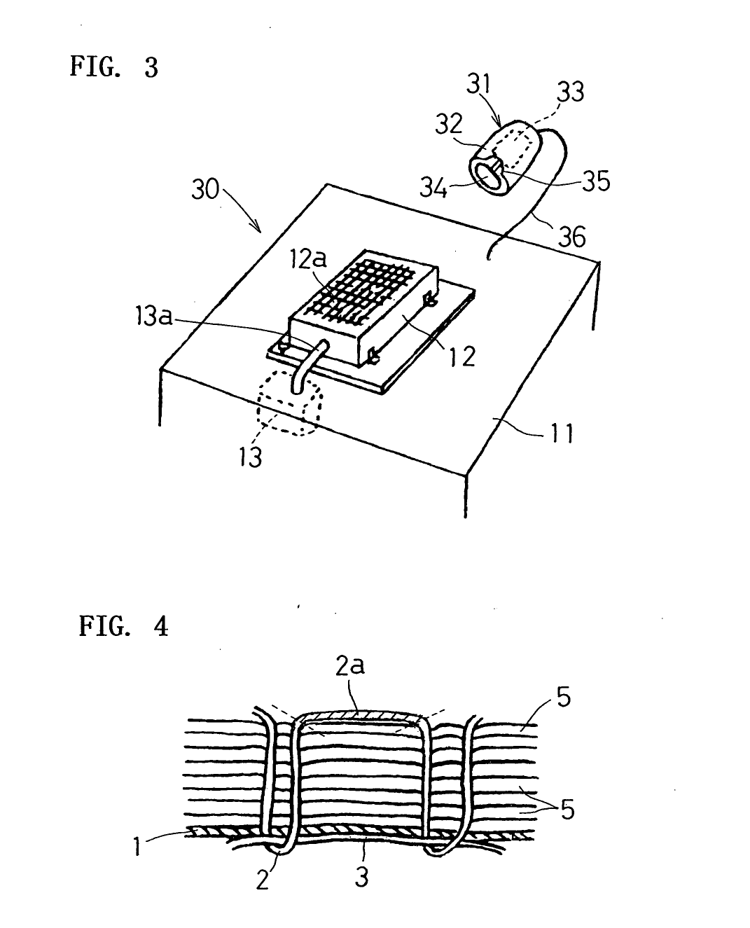

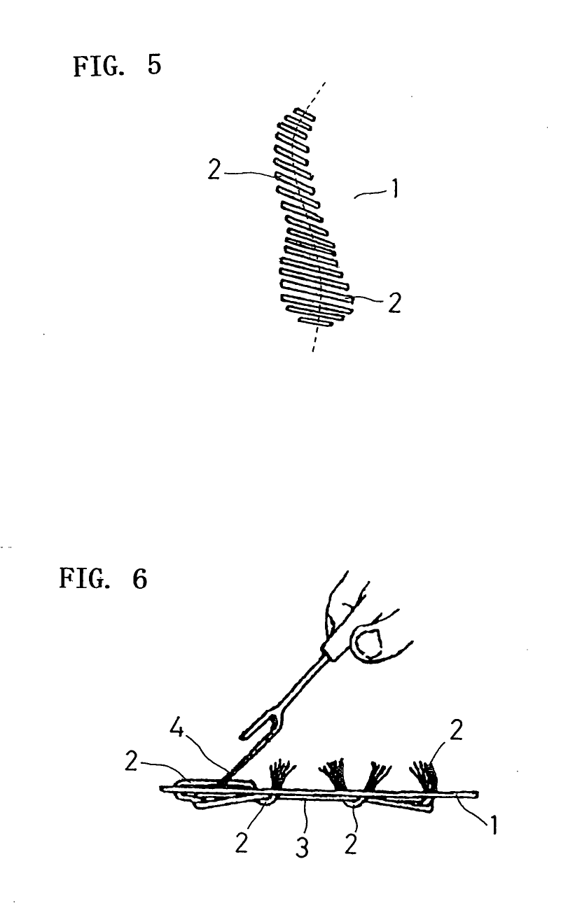

FIGS. 1 and 2 show devices capable of automatically cutting and removing or cutting off the needle threads. On the other hand, FIG. 3 shows a semiautomatic treating device 30 having a handy cutter.

More specifically, a cloth support table 12 is fixed to a workbench 11, and a vacuum device 13 is connected to the cloth support table 12. Numeral 31 designates a handy cutter unit that is used with these as a set. The cutter unit 31 has a size and a weight suited for use with one hand. A small motor 33 is incorporated in the cap 32 of the cutter unit 31, and a rotating cutter 34 is installed at the tip of its output shaft. For safety, the rotating cutter 34 is surrounded by the fringe of the cap 32. A cutout portion 35 is formed in a part of the fringe so that the rotating cutter 34 is exposed partially. Numeral 36 designates an electric power cord connected to an electric power supply portion inside the workbench 11.

The treating device 30 is configured as described above. The treatment for the embroidery cloth 1 is carried out by holding the cutter unit 31 with one hand and by operating it. In other words, an embroidery cloth 1 is stacked with one to a plurality of sheets 5 and embroidered. The needle threads 2 and bobbin threads 3 appearing on the back surface of the embroidery cloth 1 are bonded and fixed thereto. The embroidery cloth 1 with the sheets 5 stacked thereon is placed on the plate 12a of the cloth support table 12 while the cloth 1 is directed downward. The vacuum device 13 is operated, and the embroidery cloth 1 and the sheets 5 are sucked and fixed to the plate 12a. Next, the small motor 33 of the handy cutter unit 31 is driven, and the rotating cutter 34 is moved along the surface of the uppermost sheet 5 to cut and remove the intermediate portions 2a of the needle threads 2. Or the rotating cutter 34 is pushed between any two vertically adjacent sheets 5 and 5 to cut off the needle threads 2. As a result, the needle threads 2 are obtained in an erected state so as to have a height corresponding to the number of the stacked sheets 5. This treating device 30 is particularly suited for relatively small embroidery patterns or for partial treatment or correction.

A disc-shaped rotating cutter is used as a cutter in each of the above-mentioned embodiments. However, the cutter is not limited to this type of cutter. In other words, various types of cutters can be used. For example, it is possible to use a cutter similar to a hair clipper wherein one of cutter blades is reciprocated to perform cutting. Or it is possible to use a cutter or the like wherein a cylindrical or column-shaped member provided with a cutter blade, such as a rotating plane, is supported horizontally and rotated orthogonally to the sliding direction. Or it is possible to use a long cutter to perform cutting and removing or cutting off while being reciprocated orthogonally to the sliding direction or without being reciprocated.

### Industrial Applicability

As described above, the device in accordance with the present invention can easily set the needle threads in an erected state so as to have a desired height, thereby being useful as a device for obtaining stereoscopic imposing embroidery patterns.

1: An embroidery surface treating device comprising a cloth support table (12) having an air-permeable plate (12a) at an opening part on the upper surface thereof, a suction device (13) for sucking, from underside, an embroidery cloth (1) embroidered in a state stacked with one to a plurality of sheets (5) and placed on said cloth support table (12), and a cutter (18) for sequentially cutting and removing all the needle threads (2) of embroidery patterns appearing on the surface of the uppermost sheet of said plurality of sheets stacked on said embroidery cloth (1) placed on said cloth support table (12) by carrying out operation while relatively moving in parallel with the surface of said cloth support table (12) in a state of shaving off all the needle threads or for sequentially cutting off all the needle threads (2) of embroidery patterns between any adjacent sheets (5) and (5) of said plurality of stacked sheets (5) in a state of cutting and separating off all the needle threads vertically by inserting the cutter therebetween.

2: An embroidery surface treating device in accordance with claim 1, wherein said cloth support table (12) is fixed, and said cutter (18) is moved by moving means (14).

3: An embroidery surface treating device in accordance with claim 1, wherein said cutter (18) is fixed, and said cloth support table (12) is moved by moving means (14).

4: An embroidery surface treating device comprising a cloth support table (12) having an air-permeable plate (12a) at an opening part on the upper surface thereof, a suction device (13) for sucking, from underside, an embroidery cloth (1) embroidered in a state stacked with one to a plurality of sheets (5) and placed on said cloth support table (12), and a handy cutter unit (31) for sequentially cutting and removing all the needle threads (2) of embroidery patterns appearing on the surface of the uppermost sheet of said plurality of sheets stacked on said embroidery cloth (1) placed on said cloth support table (12) by carrying out operation while moving in parallel with the surface of said cloth support table (12) in a state of shaving off all the needle threads or for sequentially cutting off all the needle threads (2) of embroidery patterns between any adjacent sheets (5) and (5) of said plurality of stacked sheets (5) in a state of cutting and separating off all the needle threads vertically by inserting said cutter therebetween.
